(19) United States
(12) Patent Application Publication
(10) Pub. No.: US 2008/0225394 A1
(43) Pub. Date: Sep. 18, 2008

(54) Optical element

(75) Inventors: Ying-Hsiu Lin, Zhuangwei Shiang (TW); Po-Hung Yao, Luzhu Shiang (TW); Wen-Hsun Yang, Taipei City (TW)

Correspondence Address: REED SMITH LLP, Suite 1400, 3110 Fairview Park Drive, Falls Church, VA, 22042, US

(73) Assignee: Industrial Technology Research Institute

(21) Appl. No.: 11/797,183

(22) Filed: May 1, 2007

(30) Foreign Application Priority Data
Mar. 12, 2007 (TW) 096108370

(51) Int. Cl. G02B 5/02

(52) U.S. Cl. 359/599

(57) ABSTRACT

An optical element is provided in the present invention, which comprises an element body and a plurality of microlens elements. The element body has a first surface disposed thereon. The plural microlens elements are arranged two-dimensionally on the first surface. The size and shape for each microlens elements may be different from each other and the arrangement for the plural microlens elements on the first surface may be random and arbitrary so that the optical element of the present invention are capable of performing light diffusion and light-redirecting effects without generating interference fringes.

### FIELD OF THE INVENTION

The present invention relates to an optical element, and, more specifically, to an optical element having characteristics of being arranged two-dimensionally on the surface thereof, while at same time providing results of light-redirecting and light diffusion.

### BACKGROUND OF THE INVENTION

Currently, backlight module basically uses a diffuser and a brightness enhancement film (BEF) or dual brightness enhancement film (DBEF) to achieve purpose of uniform luminance and enhance brightness. Please refer to FIG. 1, which illustrates a conventional BEF utilized in the backlight module. In such conventional art, the BEF 1 comprises a plurality of v-shape elements 10 arranged periodically on the surface of the BEF 1. The arrangement of v-shape elements 10 in FIG. 1 may effectively improve the brightness of the normal direction from the backlight module; however, it may also induce interference fringes visibly by naked eye of user, which is an undesirable effect, Moire.

A conventional technique, disclosed in U.S. Pat. No. 5,919,551, provides a structured optical film with variable pitch peaks and/or grooves to reduce the visibility of Moire. Other technique, such as U.S. Pat. No. 6,862,141, also discloses an optical substrate which features a three-dimensional surface having a correlation length of about 1 cm or less. The optical substrate provide a variety of functions, including brightness enhancement and for reducing or eliminating Moire artifacts caused by many common light-redirecting films.

### SUMMARY OF THE INVENTION

The present invention is to provide an optical element having a plurality of microlens elements disposed two-dimensionally on the surface thereof with regular or irregular arrangement and different size and shape characteristics so as to eliminate interference patterns or fringes and provide effects of light-redirecting and light-diffusion.

In one embodiment of the present invention, an optical element, comprising: an element body having a first surface, and a plurality of microlens elements arranged two-dimensionally on the first surface.

In another embodiment, the microlens element is a polyhedron structure, wherein each facet of the polyhedron structure is a polygon. In addition, top-form of the polyhedron structure is capable of being selected from a group consisting of a point, a crest line and a plane wherein a height between the crest line and the bottom surface of the microlens element is between 1 μm and 100 μm. Besides, the plane is a polygon and height between the plane and the bottom surface of the microlens element is between 1 μm and 100 μm.

In another embodiment, the microlens element further has a pair of principal facets and a plurality of secondary facets connected to the pair of principal facets, wherein an included angle between the pair of principal facets is greater than 0 degree and smaller than 90 degree and each of the principal facets further has a vertex angle, which is between 30 and 150 degree.

In another embodiment, the element body is formed of a transparent polymer material which has ingredients selected from a group consisting of diffusion particles and liquid crystal molecules. Besides, the element body may be made of a material with gradually varied refractive index.

In another embodiment, the element body further includes a second surface disposed correspondingly to the first surface, wherein the second surface is selected from a group consisting of a smooth surface and a rough surface.

In another embodiment, the plurality of microlens elements can be disposed in array arrangement on the first surface. In addition, the plurality of microlens elements may also be disposed randomly on the first surface.

In another embodiment, the plurality of microlens elements are composed of at least one kind of structure, i.e. size and shape of the microlens elements may be different from each other.

### BRIEF DESCRIPTION OF THE DRAWINGS

The drawings, incorporated into and form a part of the disclosure, illustrate the embodiments and method related to this invention and will assist in explaining the detail of the invention.

FIG. 1 is a sketch illustrating a conventional BEF utilized in the backlight module.

FIG. 2A illustrates a cross-sectional view of an embodiment of an optical element according to the present invention.

FIG. 2B illustrates an oblique-view of an embodiment of an optical element according to the present invention.

FIG. 3 depicts a first embodiment of a microlens element according to the present invention.

FIG. 4A illustrates a second embodiment of an optical element according to the present invention.

FIG. 4B illustrates a lateral-view of the microlens element shown in the FIG. 4A.

FIG. 4C illustrates another embodiment of lateral-view of the microlens element according to FIG. 4A.

FIG. 5A and FIG. 5B illustrate a third embodiment of the microlens element according to the present invention.

FIG. 6 illustrates the fourth embodiment of the microlens element according to the present invention.

FIG. 7A depicts an optical simulation result of the optical element analyzed by autocorrelation image.

FIG. 7B illustrates a simulation result for performance of the light-redirecting of the optical element according to the present invention.

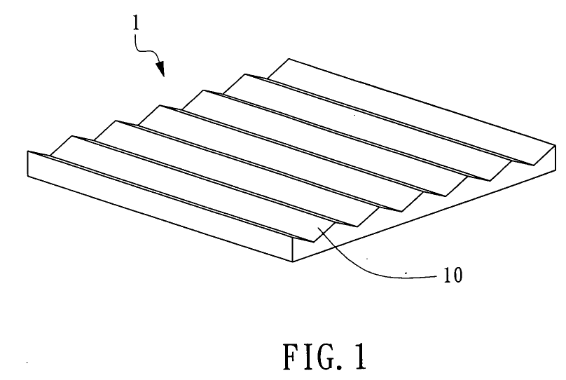

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

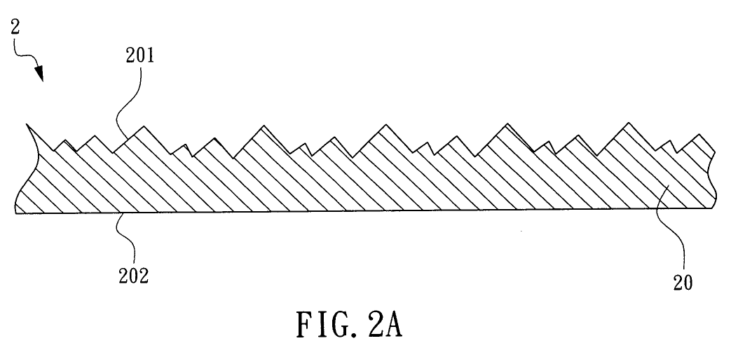

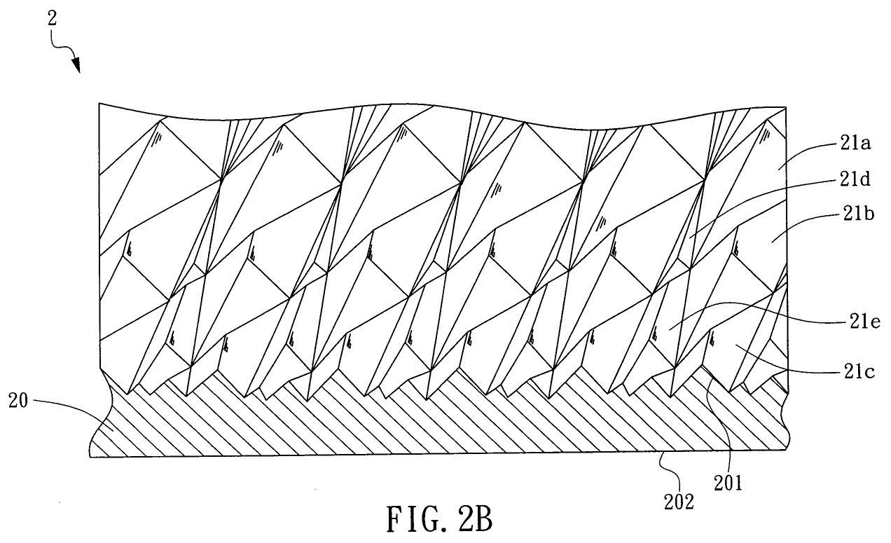

Please refer to FIG. 2A, which is a cross-sectional view of an embodiment of an optical element according to the present invention. The optical element 2 comprises an element body 20, which is made of a polymer material. The polymer material may contain diffusion particles or may contain liquid crystal molecules. Alternatively, the element body 20 may be composed of a material with gradually varied refractive index.

Please refer to FIG. 2B, which is an oblique-view of an embodiment of an optical element according to the present invention. The element body 20 has a first surface 201 and a second surface 202. The first surface 201 has a plurality of microlens elements 21a˜21e disposed thereon. The plurality of microlens elements 21a˜21e may contain at least of one kind of structure, i.e. the size and shape for each microlens element 21a˜21e may be different from each other or the same as each other. Each microlens element 21a˜21e is a polyhedron structure whose top-form is capable of being defined as a structure selected from a group consisting of a point, a crest line and a plane. The second surface 202 is disposed correspondingly to the first surface 201 and is substantially a smooth surface or a rough surface.

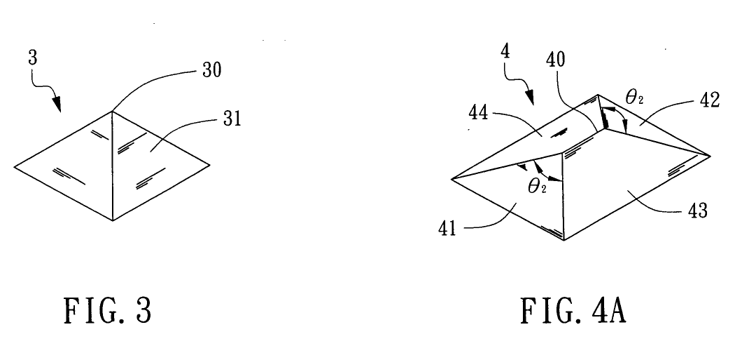

Next, embodiments of microlens element according to the present invention are explained in the following. Please refer to FIG. 3, which depicts a first embodiment of a microlens element according to the present invention. In the first embodiment, the top-form of the microlens element 3, a polyhedron structure, is a point 30 where a plurality of polygons 31 are formed therefrom. The one side of each polygon 31 is connected to the first surface 201 shown in FIG. 2A or FIG. 2B. The polygon 31 in the first embodiment is a triangle, but should not be a limitation to the present invention.

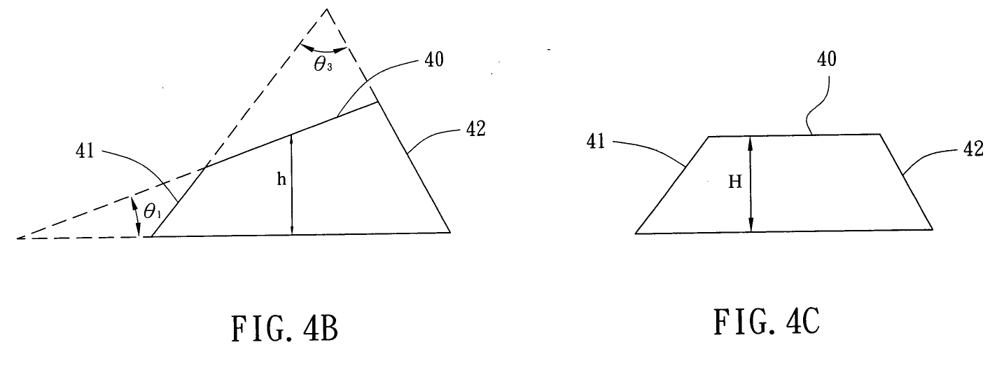

Please refer to FIG. 4A, which is a second embodiment of an optical element according to the present invention. In the second embodiment, the top-form of the microlens structure 4, a polyhedron structure, is a crest line 40 and the lateral of the microlens element 4 is formed by the plural facets 41, 42, 43, and 44 connected to each other, wherein the crest line 40 is formed by the plural facets 41, 42, 43, and 44. In the second embodiment, the plural facets 41, 42, 43, and 44 of the microlens element may be formed by a plurality of triangles, a plurality of rectangles, or other polygons, or the combination thereof.

Please refer to FIG. 4B, which is a lateral-view of the microlens element shown in the FIG. 4A. In FIG. 4B, height h between the crest line 40 and the bottom of the microlens element is varied with different location of the bottom, i.e. an included angle θ₁ is formed between the bottom of the microlens element and the crest line 40 and the range of the height h is between 1 μm and 100 μm.

In addition to FIG. 4B, other embodiment like FIG. 4C, which is another embodiment of the microlens according to FIG. 4A, is also disclosed. In FIG. 4C, the crest line 40 of the microlens element is parallel to the bottom of the microlens element, and the height H between thereof is between 1 μm and 100 μm.

Back to FIG. 4A, the microlens element 4 is defined by a pair of principal facets 41 and 42 and a plurality of secondary facets 43 and 44 connected to the pair of principal facets 41, 42, wherein the principal facets 41, 42 or the secondary facets 43, 44 may be a polygon such as triangle, rectangle, pentagon or other polygon. In the present embodiment, the principal facet 41 or 42 is a triangle while the secondary facet 43 or 44 is a rectangle.

Each of the principal facets 41, 42 further has a vertex angle θ₂ connected to the crest line 40 of the microlens element 4. The scale of the vertex angle θ₂ will affect the performance of light-redirecting of the microlens element 4. The degree measure of the vertex angle θ₂ is between 30 and 150 degree. Besides, the vertex angle θ₂ of each principal facet 41 or 42 may be different or the same. In addition, an included angle θ₃ defined between the pair of the principal facets 41 and 42, shown in FIG. 4B, is between 0 and 90 degree.

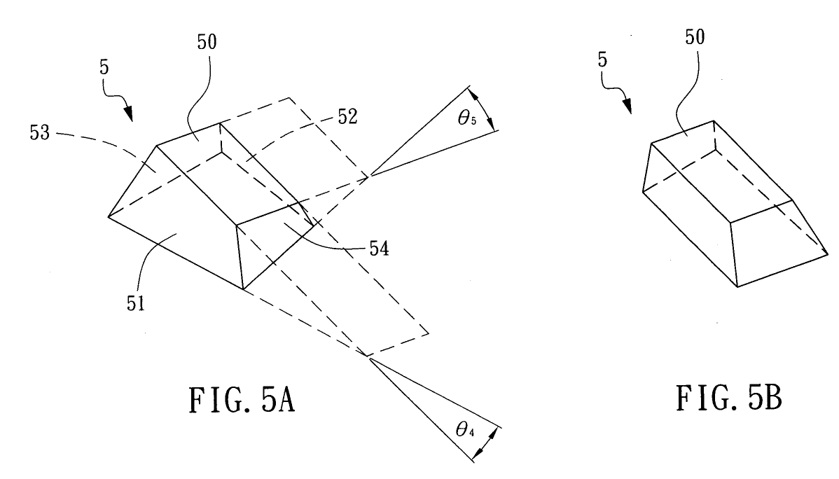

Please refer to FIG. 5A, which is a third embodiment of the microlens element according to the present invention. In this embodiment, the microlens element 5 is a polyhedron structure whose top-form is a plane 50 with four facets 51˜54 connected to the sides thereof. Two included angles θ₄, θ₅ are formed between the plane 50 and the bottom of the microlens element 5. Meanwhile, the height between the plane 50 and the bottom of the microlens element 5 is between 1 μm and 100 μm. Aside from the included angles θ₄, θ₅ between the plane 50 and the bottom of the microlens element 5, like another embodiment shown in the FIG. 5B, the plane 50 may be parallel to the bottom of the microlens element and the height between the plane 50 and bottom of the microlens element is between 1 μm and 100 μm.

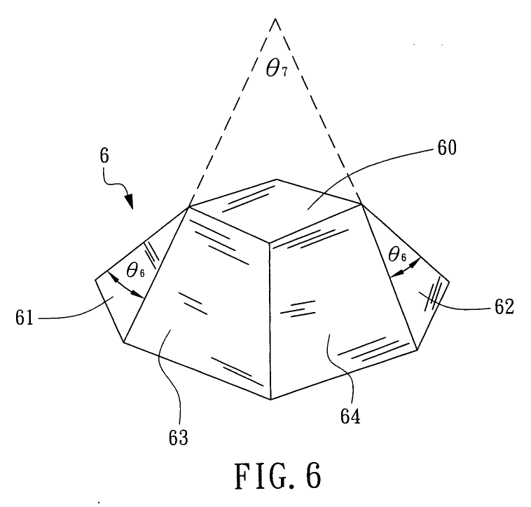

FIG. 6 illustrates another embodiment of the microlens element according to the present invention. In the embodiment, the microlens element 6 is a polyhedron structure, which is defined by a pair of principal facets 61, 62 and a plurality of facets 63, 64 wherein the principal facet 61, 62 or the secondary facet 63, 64 is a triangle, rectangle, or polygon. In the embodiment, the principal facet 61 or 62 is a triangle and the secondary facet 63 or 64 is a rectangle, but should not be a limitation in the present invention.

Each of the principal facets 61 and 62 has a vertex angle θ₆ respectively, connected to the plane 60 of the microlens element 6 and the angle measure of the vertex angle θ₆ is between 30 and 150 degree. Besides, the vertex angle θ₆ of each principal facet 61, 62 may be the same as or different from each other. Meanwhile, the included angle θ₇ defined between the principal facets 61, 62 is between 0 and 90 degree.

According to the embodiments described above, the optical element according to the present invention can not only hold the effect of light-redirecting and light diffusion, but also eliminate interference fringes, wherein the surface comprises the plurality of microlens elements arranged in array, and the size and shape for each microlens element may be different from each other.

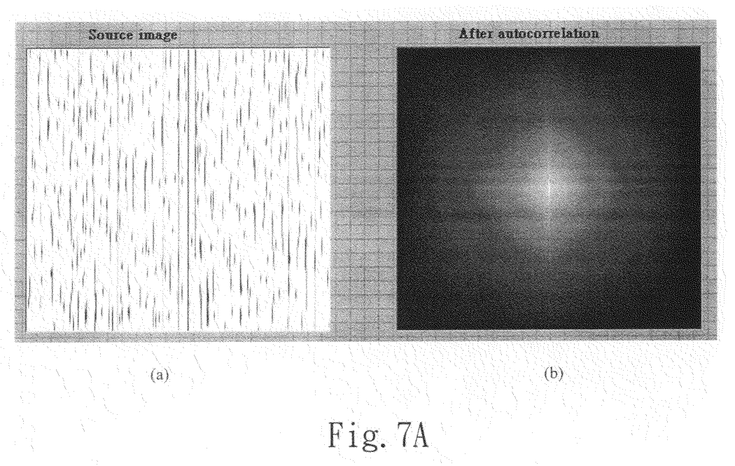

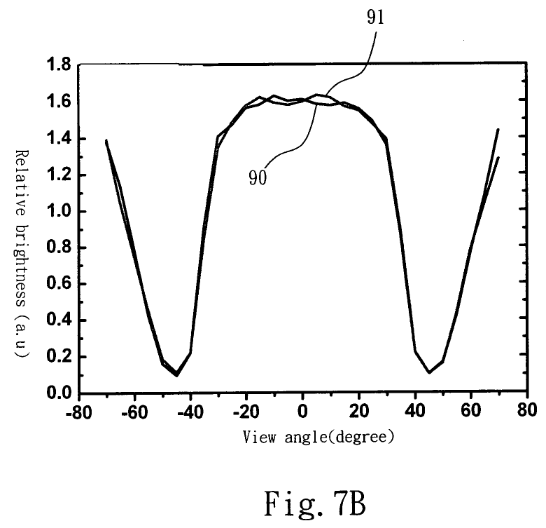

By means of analysis of the autocorrelation image, the optical element with irregular arrangement of microlens elements according to the present invention can eliminate interference fringes arisen in the conventional arts, which is shown in FIG. 7A, wherein FIG. 7A (a) is an original graph of the optical element according to the present invention, while FIG. 7A (b) illustrates a consequence calculated by autocorrelation, where periodic interference fringes are not occurred.

Aside from the result of eliminating interference fringes, the optical element can also perform effective light-redirecting. In the FIG. 7B, curve 90 refers to a light-redirecting effect of the conventional optical element BEF 90/50 while curve 91 refers to a light-redirecting result of the optical element according to the present invention. From the result shown in FIG. 7B, the optical element of the present invention maintains almost the same performance of light-redirecting as the conventional optical element BEF 90/50 under the situation that do not generate any interference fringes.

While the embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An optical element, comprising:
an element body having a first surface; and
a plurality of microlens elements arranged two-dimensionally on the first surface.

2. The optical element according to claim 1, wherein the microlens element is a polyhedron structure.

3. The optical element according to claim 2, wherein each facet of the polyhedron structure is a polygon.

4. The optical element according to claim 2, wherein top-form of the polyhedron structure is capable of being selected from a group consisting of a point, a crest line and a plane.

5. The optical element according to claim 4, wherein the crest line is parallel to the bottom surface of the polyhedron structure.

6. The optical element according to claim 4, wherein the crest line is formed at an angle with respect to the bottom surface of the polyhedron structure.

7. The optical element according to claim 4, wherein a height between the crest line and the bottom surface of the microlens element is between 1 μm and 100 μm.

8. The optical element according to claim 4, wherein the plane is a polygon.

9. The optical element according to claim 4, wherein the plane is parallel to the bottom surface of the polyhedron structure.

10. The optical element according to claim 4, wherein the plane is formed at an angle with respect to the bottom surface of the polyhedron structure.

11. The optical element according to claim 2, wherein the microlens element further has a pair of principal facets and a plurality of secondary facets connected to the pair of principal facets.

12. The optical element according to claim 11, wherein an included angle between the pair of principal facets is greater than 0 degree and smaller than 90 degree.

13. The optical element according to claim 12, wherein each of the principal facets further has a vertex angle whose degree measure is between 30 and 150 degree.

14. The optical element according to claim 1, wherein the element body is formed of a transparent polymer material.

15. The optical element according to claim 14, wherein the polymer material further has ingredients selected from a group consisting of diffusion particles and liquid crystal molecules.

16. The optical element according to claim 1, wherein the element body is made of a material with gradually varied refractive index.

17. The optical element according to claim 1, wherein the element body further includes a second surface which is disposed correspondingly to the first surface and is selected from a group consisting of a smooth surface and a rough surface.

18. The optical element according to claim 1, wherein the plurality of microlens elements are disposed in array arrangement on the first surface.

19. The optical element according to claim 1, wherein the plurality of microlens elements are disposed randomly on the first surface.

20. The optical element according to claim 1, wherein the plurality of microlens elements are composed of at least one kind of structure.
